(19) United States
(12) Patent Application Publication
(10) Pub. No.: US 2012/0253644 A1
(43) Pub. Date: Oct. 4, 2012

(54) METHOD FOR OPERATING AN INTERNAL COMBUSTION ENGINE

(75) Inventor: Thomas Port, Stuttgart (DE)

(73) Assignee: ROBERT BOSCH GMBH, Stuttgart (DE)

(21) Appl. No.: 13/434,719

(22) Filed: Mar. 29, 2012

(30) Foreign Application Priority Data
Mar. 29, 2011 (DE) 10 2011 006 363.3

(51) Int. Cl. F02D 41/04

(52) U.S. Cl. 701/109

(57) ABSTRACT

A method for operating an internal combustion engine, in which at least one unwanted exhaust component is reduced, wherein a comparison value of an air ratio is determined and compared with an actual air ratio, and/or a comparison value of an oxygen fraction in an intake pipe is determined and compared with an actual oxygen fraction in the intake pipe, and wherein at least one correction variable is determined in accordance with a result of the comparison for the purpose of correcting at least one variable acting on the actual air ratio and/or the actual oxygen fraction in the intake pipe.

### BACKGROUND OF THE INVENTION

The invention relates to a method for operating an internal combustion engine, and to a computer program and an open-loop and/or closed-loop control device for operating an internal combustion engine.

The continuous tightening of pollutant emissions limits imposes demanding requirements on modern internal combustion engines. In the case of diesel engines, this applies especially to soot and nitrogen oxide emissions (NOx). One known practice in the prior art is to use exhaust gas recirculation (EGR), which represents an important means of reducing nitrogen oxide formation. The principle of operation is based on lowering the oxygen content in the cylinders and consequently lowering the temperature in the combustion chambers.

In general, an increasing EGR rate in diesel engines is also accompanied by. an increase in the relative proportion of soot particles. Often, the main reason for this is the limitation of the oxygen required for soot oxidation. The reduction in the oxygen content due to EGR may therefore have the effect of reducing NOx emissions and increasing soot emissions. In the case of diesel engines, this gives rise to a conflict of aims as between soot and NOx emissions.

In the case of dynamic load changes, existing EGR control concepts lead to significant spikes in emissions if the dynamic change in the torque buildup is maintained.

### SUMMARY OF THE INVENTION

The invention starts from the consideration that at least one unwanted exhaust component is produced during the operation of an internal combustion-engine, e.g. a diesel engine, said component being monitored continuously during operation and as far as possible reduced by various devices and/or methods. For this purpose, it is possible, for example, to perform open-loop or closed-loop control of an actual air ratio of the internal combustion engine, of an actual oxygen fraction in an intake pipe of the internal combustion engine, of an air mass flow fed to the internal combustion engine and/or of an exhaust gas recirculation rate. The air ratio (lambda, also known as “combustion air ratio”) describes the mixture composition fed to the internal combustion engine, consisting of air—or the oxygen contained in the air—and fuel.

It is assumed here that—for given injection parameters—the formation of the unwanted exhaust components (pollutants) depends essentially on the actual air ratio and on the actual oxygen fraction in the intake pipe of the internal combustion engine. The unwanted exhaust components may temporarily be particularly high, especially in the case of dynamic operation of the internal combustion engine, i.e., while a fuel quantity supplied, a speed, and/or a torque of the internal combustion engine are changing.

According to the invention, a comparison value of an air ratio (“calculated air ratio”) is determined and compared with the actual air ratio. In addition or alternatively, a comparison value of an oxygen fraction (“calculated oxygen fraction”) in the intake pipe of the internal combustion engine is determined and compared with the actual oxygen fraction in the intake pipe of the internal combustion engine. Depending on a result of the comparison, at least one correction variable—e.g., a delta value—is determined and used for the purpose of correcting at least one variable acting on the actual air ratio and/or the actual oxygen fraction in the intake pipe. This variable can be almost any variable associated with the internal combustion engine and/or with an air system and/or with an exhaust system of the internal combustion engine as long as the variable acts—at least indirectly—on the actual air ratio and/or the actual oxygen fraction in the intake pipe.

It goes without saying that the method according to the invention can be employed for diesel engines, spark ignition engines or other internal combustion engines, provided the internal combustion engine has devices for reducing at least one unwanted exhaust component.

The invention has the advantage that, firstly, the quantity of unwanted exhaust components can be kept comparatively low and “spikes in emissions” are lowered in dynamic operation of the internal combustion engine. Secondly, it is possible—in the case where there are several unwanted exhaust components—to weight the emissions relative to one another and to shift the relative concentrations of the emissions, at least temporarily, both in the case of dynamic and of steady-state operation. It is thus possible to reduce individual exhaust components preferentially, and an optimum compromise between the various requirements can thus be achieved, even in dynamic operation. The overall effectiveness of exhaust gas aftertreatment can thereby be improved. Thirdly, the applications for steady-state operation of the internal combustion engine and/or of the exhaust system can be retained because, according to the invention, the variables and/or setpoints determined by the applications have only to be corrected temporarily, when required, by means of the at least one correction variable. Fourthly, it is possible to dispense with an “NOx allowance” in steady-state operation of the internal combustion engine.

In particular, provision is made for the at least one variable acting on the actual air ratio and/or the actual oxygen fraction in the intake pipe to be a setpoint for closed-loop control of the actual air ratio and/or of the actual oxygen fraction and/or of an air mass flow and/or of an exhaust gas recirculation rate and/or of an oxygen mass in a cylinder charge and/or of an inert gas rate and/or of an inert gas mass in a cylinder charge. The method according to the invention can thus be used to complement one or more control devices which perform open-loop or closed-loop control of the internal combustion engine and/or the air system and/or the exhaust system. In this method, at least one setpoint of at least one of the control devices can be varied by means of the at least one correction variable. As a supplementary measure, additional variables and/or conditions can be applied to the correction of the at least one setpoint, as will be described further below. Control of the exhaust gas recirculation rate (“EGR control”) has a comparatively large effect on the actual air ratio and the actual oxygen fraction. The method according to the invention can therefore be applied with particular advantage to EGR control.

The method can be improved if the correction variables are determined while allowing for actual variables of an injection system of the internal combustion engine and/or of the air system and/or of the exhaust system of the internal combustion engine. This enables the correction variables to be determined in a particularly appropriate way for a particular operating state, and thus enables the unwanted exhaust components to be reduced to a greater extent.

Provision is furthermore made for the at least one correction variable to be formed and/or used only when the result of the comparison and/or the respective correction variable exceeds or undershoots a respective threshold value. This ensures that the correction variables change the setpoints only when and/or to the extent that an overall reduction in the unwanted exhaust components is accomplished. The method according to the invention can be used to supplement any emission control system that is present and generally intervenes in the emission control process only when the threshold values associated with the method are exceeded or undershot. Thus, the method preferably operates when a deviation in the emissions which is defined as impermissible relative to comparable values for steady-state operation of the internal combustion engine is detected or can be assumed.

In particular, provision is made for at least two unwanted exhaust components to be reduced, and for at least one correction variable to be determined for each of the unwanted exhaust components, and for the correction variables determined in this way each to be rated individually, and for the correction variables rated in this way to be used to correct the at least one setpoint. For example, a sum of the correction variables determined in this way can be formed and used to correct the at least one setpoint. In this way, a number of unwanted exhaust components can be allowed for simultaneously, and the individual rating enables the relative concentrations of the emissions to be adjusted when required. If appropriate, a first exhaust component can be reduced to a greater extent than a second or third exhaust component, or vice versa. Allowing for the capacity of a catalytic converter and/or particulate filter present in the exhaust system of the internal combustion engine, it is thus possible to minimize the exhaust components overall. Individual rating of the correction variable(s)—and hence the different weighting of the exhaust components—can be accomplished by means of the threshold values or, alternatively, by means of weighting factors.

By way of example, a first unwanted exhaust component can be soot and a second unwanted exhaust component can be at least one nitrogen-oxygen compound (NOx, nitric oxide). This is significant especially in the case of diesel engines, where there is a “conflict of aims” between the two exhaust components. On the one hand, a reduced oxygen fraction in the intake path of the internal combustion engine reduces NOx emissions but, on the other hand, it increases soot emissions and vice versa. The method according to the invention creates additional ways of overcoming this conflict of aims, both in the case of steady-state and/or of dynamic operation. For example, an “NOx allowance”, with which higher NOx emissions in dynamic operation are balanced out by adjusted settings in steady-state operation, may be unnecessary when using the method according to the invention. It is thereby possible to reduce fuel consumption.

The invention furthermore provides for the comparison value of the air ratio to be determined in accordance with a soot limit value dependent on the operating point and/or with a soot fraction in steady-state operation of the internal combustion engine and/or with a reference air ratio in steady-state operation of the internal combustion engine. By way of example, the comparison value of the air ratio can be determined by means of a formula

$$SZ \text{?} SZo \cdot ( \text{?} ) , \\ \text{?} \text{indicates text missing or illegible when filed}$$

where “SZ” is a soot limit value dependent on the operating point, “SZo” is a soot fraction in steady-state operation of the internal combustion engine, “λₒ” is a reference air ratio in steady-state operation of the internal combustion engine, “λ” is the comparison value of the air ratio (“calculated” air ratio) of the internal combustion engine, and “n” is an exponent dependent on the operating point. This describes a first emissions model for the production of soot. According to the invention, the emissions model is used inversely, i.e. the soot limit value SZ dependent on the operating point, the soot fraction SZo in steady-state operation of the internal combustion engine and the reference air ratio λₒ are inserted into the above equation to obtain the calculated air ratio (λ, lambda). The calculated air ratio λ obtained in this way can then be compared with the actual air ratio in order to obtain the correction variables. The above formula establishes a particularly accurate correlation between the variables used. As an alternative, however, any other invertible emissions model with an accuracy sufficient for the purpose described may also be used.

The invention furthermore provides for the comparison value of the oxygen fraction to be determined in accordance with an NOx limit value dependent on the operating point and/or with an NOx fraction in steady-state operation of the internal combustion engine and/or with a reference oxygen fraction in steady-state operation of the internal combustion engine. By way of example, the comparison value of the oxygen fraction is determined by means of a formula

$$NOx = NOxo \cdot ( \text{?} ) , \\ \text{?} \text{indicates text missing or illegible when filed}$$

where “NOx” is an NOx limit value dependent on the operating point, “NOxo” is an NOx fraction in steady-state operation of the internal combustion engine, “ψ_{O2o}” is a reference oxygen fraction in steady-state operation of the internal combustion engine, “ψ_{O2}” is the comparison value of the oxygen fraction (“calculated” oxygen fraction) in the intake pipe of the internal combustion engine, and “k” is an exponent dependent on the operating point. This describes a second emissions model for the production of nitrogen oxides (NOx). According to the invention, the second emissions model is also used inversely, i.e., the NOx limit value NOx dependent on the operating point, the NOx fraction NOxo in steady-state operation of the internal combustion engine and the reference oxygen fraction ψ_{O2o} are inserted into the above equation to obtain the calculated oxygen fraction ψ_{O2o}. The calculated oxygen fraction ψ_{O2} determined in this way can then be compared with the actual oxygen fraction in order to determine the correction variables. The above formula establishes a particularly accurate correlation between the variables used. Here too, any other sufficiently accurate and invertible model may be used.

As a supplementary measure, provision is made for the actual air ratio and/or the actual oxygen fraction in the intake pipe to be determined by means of at least one sensor and/or at least one model. This enables the method according to the invention to be adapted flexibly to a particular embodiment of the internal combustion engine or of the exhaust system. It is thus possible to measure the air ratio and/or the oxygen fraction directly or to determine them indirectly.

Provision is furthermore made for at least one of the following variables:
the soot limit value dependent on the operating point;
the soot fraction in steady-state operation;
the reference air ratio;
the NOx limit value dependent on the operating point;
the NOx fraction in steady-state operation;
the reference oxygen fraction; and/or
the exponent “n” or “k” dependent on the operating point, which is a component in a formula for combining in each case at least two of said variables.

The variables are determined by means of at least one characteristic or at least one characteristic map. This is particularly advantageous because said variables are comparatively dependent on an operating state of the internal combustion engine. Using characteristics, characteristic maps or tables makes it possible to simplify and accelerate processing in an open-loop and/or closed-loop control device of the internal combustion engine or of the vehicle.

The method according to the invention can be carried out particularly well by means of a computer program. The computer program is preferably stored on a memory of the open-loop and/or closed-loop control device of the internal combustion engine.

### BRIEF DESCRIPTION OF THE DRAWINGS

Features of importance for the invention can furthermore be found in the following drawings, wherein the features may be important for the invention either singly or in various combinations even if no further explicit reference is made to this fact.

Illustrative embodiments of the invention are explained below with reference to the drawing, in which:

FIG. 1 shows a diagram of an internal combustion engine having an air system and an exhaust system; and

FIG. 2 shows a block diagram intended to illustrate the method.

### DETAILED DESCRIPTION

Identical reference signs are used for functionally equivalent elements and variables in all the figures, even where the embodiments are different.

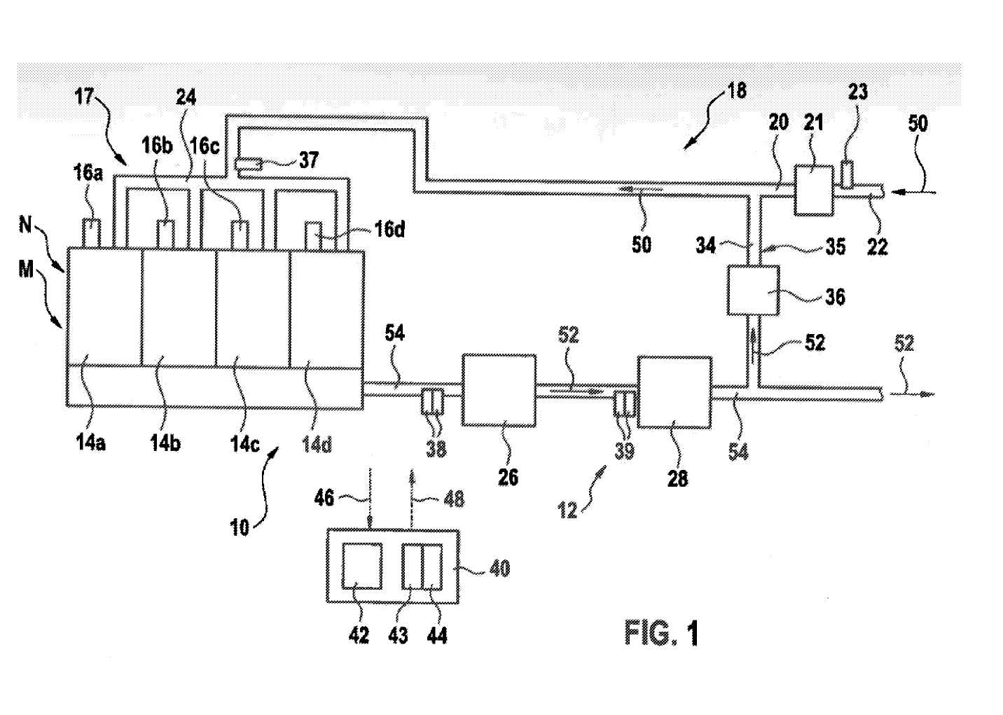

FIG. 1 shows a highly simplified schematic representation of an internal combustion engine 10 having an exhaust system 12. The internal combustion engine 10 on the left of the drawing has four cylinders 14a to 14d, into which fuel can be injected by means of four injection valves 16a to 16d. The injection valves 16a to 16d are part of an injection system 17 of the internal combustion engine 10. An air system 18 comprises an air duct 20 and an intake pipe 24, which is arranged adjacent to the internal combustion engine 10. At the top right in the drawing, the air system 18 has an actuator 21 for controlling the quantity of air flowing in. An air mass flow 22, which can be measured by an air mass meter 23 arranged upstream of the actuator 21, flows through the air duct 20.

Working from left to right in the drawing, a catalytic converter 26 (oxidation catalyst) and a particulate filter 28 are arranged in the exhaust system 12. An exhaust return 34 containing a valve 36 (exhaust gas recirculation valve) connects the exhaust system 12 to the air system 18. An exhaust gas recirculation rate 35 can be varied by means of the valve 36.

Exhaust probes 38 upstream of the catalytic converter 26 and exhaust probes 39 downstream of the catalytic converter 26 can determine the emissions spectrum of the exhaust gas before and after the catalytic converter 26. The exhaust probes 38 and 39 comprise a lambda probe and an NOx sensor, for example. A sensor 37 monitors an oxygen fraction in the intake pipe 24.

An open-loop and/or closed-loop control device 40, on which it is possible to run a computer program 42, is indicated schematically at the bottom of the drawing. The open-loop and/or closed-loop control device 40 furthermore comprises models 43 and characteristic maps 44. A bundle of incoming lines 46 and a bundle of outgoing lines 48 indicate various electrical connections between the open-loop and/or closed-loop control device 40 and the other electrical devices of the internal combustion engine 10, of the air system 18 and of the exhaust system 12, leading, for example, to an actuator of the valve 36 and to the sensor 37. However, these electrical connections are not shown explicitly in FIG. 1. Arrows 50 describe the direction of flow in the air system 18, and arrows 52 describe the direction of flow of an exhaust gas 54 in the exhaust system 12.

During operation, the open-loop and/or closed-loop control device 40 determines various variables of the internal combustion engine 10 and of the exhaust system 12. Among the variables detected or determined are an engine speed N and a torque M of the internal combustion engine 10, an exhaust gas temperature, the position of the valve 36, the air mass flow 22 in the air duct 20, injection times, injection durations and injection pressures in the injection valves 16a to 16d, and signals from the exhaust probes 38 and 39. However, this is not illustrated specifically in FIG. 1 of the drawing.

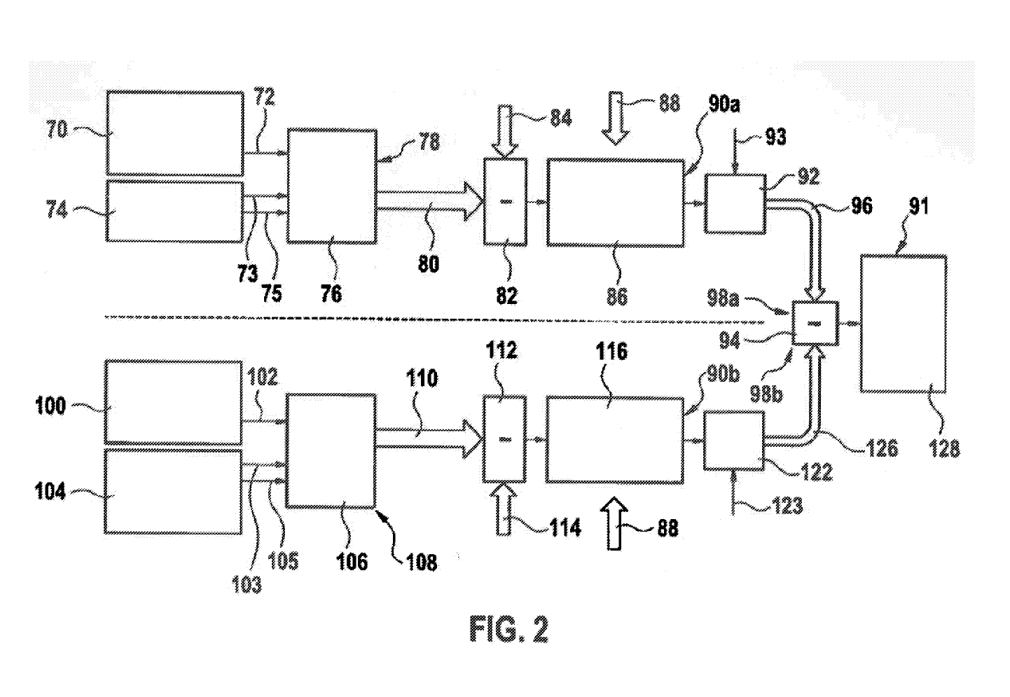

FIG. 2 shows a block diagram illustrating the implementation of the method. In the drawing, the execution of the block diagram takes place essentially from left to right. Variables and method steps for a “soot path” are shown at the top in FIG. 2, while variables and method steps for an “NOx path” are shown at the bottom. On the right in the drawing, the outputs of the soot path and of the NOx path are combined.

In the soot path, a soot limit value 72 is determined or made available in a block 70. In a block 74, a soot fraction 73 and a reference air ratio 75 are determined or made available, in each case for steady-state operation of the internal combustion engine 10. In a subsequent block 76, the soot limit value 72, the soot fraction 73 and the reference air ratio 75 are fed as input variables to a soot model 78, which is used inversely.

The soot model 78 uses the following equation:

$$SZ \text{?} SZo \cdot ( \text{?} ) , \\ \text{?} \text{indicates text missing or illegible when filed}$$

where

SZ=smoke number, corresponding in the present case to the soot limit value 72 dependent on the operating point;

SZo=reference smoke number, corresponding to the soot fraction 73 in steady-state operation of the internal combustion engine 10;

λₒ=reference air ratio 75, i.e., the air ratio in steady-state operation of the internal combustion engine 10;

λ=(calculated) air ratio 80; and

n=exponent dependent on the operating point.

The inverse use of the soot model 78 is carried out in such a way that the soot limit value 72 dependent on the operating point, the soot fraction 73 in steady-state operation of the internal combustion engine 10, and the reference air ratio 75 are inserted into the above equation in order to obtain a calculated air ratio 80 (λ, lambda).

In a subsequent block 82, a difference is formed from the calculated air ratio 80 and an actually determined air ratio 84. The calculated air ratio 80 thus also signifies a “comparison value” for the air ratio with respect to the actual air ratio 84. In accordance with this difference and with measured variables 88 of the injection system 17 and/or of other measured variables of the air system 18 and/or of the exhaust system 12, correction variables 90a (delta values) for setpoints 91 for closed-loop control of the exhaust return 34 are then determined therefrom in block 86.

In a subsequent block 92, the correction variables 90a determined in this way are compared with threshold values 93, preferably with zero. If the sign of the correction variables 90a is such that the soot fraction in the exhaust gas 54 can be reduced, the correction variables 90a are passed to a subsequent block 94. In the drawing, this is symbolized by an arrow 96. If the direction of the correction variables 90a is such that the soot fraction in the exhaust gas 54 cannot be reduced, the correction variables 90a are not passed on or a value of zero is passed on.

In the NOx path, an NOx limit value 102 dependent on the operating point is determined or made available in a block 100. In a block 104, an NOx fraction 103 in the exhaust gas 54 and a reference oxygen fraction 105 in the intake pipe 24, in each case for steady-state operation of the internal combustion engine 10, are determined or made available. In a subsequent block 106, the NOx limit value 102, the NOx fraction 103 and the reference oxygen fraction 105 are fed as input variables to an inversely used NOx model 108.

The NOx model 108 uses the following equation:

$$NOx = NOxo \cdot ( \text{?} ) , \\ \text{?} \text{indicates text missing or illegible when filed}$$

where

NOx=NOx fraction, corresponding in the present case to the NOx limit value 102 dependent on the operating point;

NOxo=reference NOx fraction, i.e. the NOx fraction 103 in steady-state operation of the internal combustion engine 10;

ψ_{O2o}=reference oxygen fraction 105 in the intake pipe 24 in steady-state operation of the internal combustion engine 10;

ψ_{O2}=(calculated) oxygen fraction 110 in the intake pipe 24; and

k=exponent dependent on the operating point.

The inverse use of the NOx model is carried out in such a way that the NOx limit value 102 dependent on the operating point, the NOx fraction 103 in steady-state operation of the internal combustion engine 10, and the reference oxygen fraction 105 are inserted into the above equation in order to obtain a calculated oxygen fraction 110 (ψ_{O2}) in the intake pipe 24.

In a subsequent block 112, a difference is formed from the calculated oxygen fraction 110 and an actually determined oxygen fraction 114. The calculated oxygen fraction 110 thus also signifies a “comparison value” for the oxygen fraction with respect to the actual oxygen fraction 114. In accordance with this difference and with the measured variables 88 of the injection system 17 and/or of the other measured variables of the air system 18 and/or of the exhaust system 12, correction variables 90b (delta values) for the setpoints 91 for closed-loop control of the exhaust return 34 are then determined therefrom in block 116.

In a subsequent block 122, the correction variables 90b determined in this way are compared with threshold values 123, preferably with zero. If the sign of the correction variables 90b is such that the NOx fraction in the exhaust gas 54 can be reduced, the correction variables 90b are passed to the subsequent block 94. In the drawing, this is symbolized by an arrow 126. If the direction of the correction variables 90b is such that the NOx fraction in the exhaust gas 54 cannot be reduced, the correction variables 90b are not passed on or a value of zero is passed on.

In block 94, a first individual weighting factor 98a is applied to correction variables 90a, and a second individual weighting factor 98b is applied to correction variables 90b. The correction variables 90a and 90b rated in this way are then combined and averaged. The correction variables 90a and 90b combined in this way can then be used in a block 128 on the right of the drawing in FIG. 2 to correct—at least temporarily—the setpoints 91 for closed-loop control of the exhaust return 34. The setpoints 91 can be setpoints for closed-loop control of the actual air ratio 84, of the actual oxygen fraction 114 in the intake pipe 24 of the internal combustion engine 10, of the air mass flow 22 and/or of the exhaust gas recirculation rate 35. Block 128 is part of the open-loop and/or closed-loop control device 40.

One of the factors that can be allowed for with the method according to the invention is the fact that the correction variables 90a of the soot path and the correction variables 90b of the NOx path may in some cases trend in opposite directions. The averaging of the correction variables 90a and 90b which takes place in block 94 allows for the requirements of the soot path and those of the NOx path to be taken into account jointly. For example, a comparatively steep increase in the soot fraction contained in the exhaust gas 54 may be prevented while a comparatively small increase in the NOx fraction takes place at the same time or vice versa.

As a supplementary measure, the relative concentrations of the emissions may be shifted toward NOx or soot by means of the threshold values 93 and 123 and/or by means of the weighting factors 98a and 98b, depending on the exhaust aftertreatment strategy chosen, without the need to modify an application for the case of steady-state operation of the internal combustion engine 10. This makes it possible to improve the overall effect of exhaust gas aftertreatment in the exhaust system 12.

The actual air ratio 84 and/or the actual oxygen fraction 114 can be determined by means of the exhaust probes 38 or 39 and/or by means of the sensor 37. As an alternative, the actual air ratio 84 and/or the actual oxygen fraction 114 can also be determined by means of models 43, using other operating variables of the internal combustion engine 10, of the air system 18 and/or of the exhaust system 12. In the present case, the values for the reference air ratio 75, for the reference oxygen fraction 105 and for the exponents n and k are stored in the open-loop and/or closed-loop control device 40 by means of the characteristic maps 44.

It goes without saying that the method can be applied not only to the exhaust return 34 (low-pressure exhaust return) shown in FIG. 1 but also to a high-pressure exhaust return. The method according to the invention can be applied to diesel engines, spark ignition engines or other internal combustion engines.

Fundamentally, the method can furthermore also be employed when the intention is to reduce just one single unwanted exhaust component or more than two unwanted exhaust components. In this case, the layout has just one path or more than two paths. However, this is not shown in FIG. 2.

The method can furthermore be employed both during dynamic operation of the internal combustion engine 10—i.e. when there is a comparatively rapid change in the injection quantity, the engine speed N or the torque M—and in the case of steady-state operation.

1. A method for operating an internal combustion engine, in which at least one unwanted exhaust component is reduced, the method comprising:
performing at least one or both of
determining a comparison value of an air ratio and comparing the comparison value of an air ratio with an actual air ratio, and
determining a comparison value of an oxygen fraction in an intake pipe and comparing the comparison value of an oxygen fraction with an actual oxygen fraction in the intake pipe;
determining at least one correction variable in accordance with a result of at least one of the comparisons for the purpose of correcting at least one variable acting on the actual air ratio and/or the actual oxygen fraction in the intake pipe.

2. The method according to claim 1, wherein the at least one variable acting on the actual air ratio and/or the actual oxygen fraction in the intake pipe is a setpoint for closed-loop control of the actual air ratio and/or of the actual oxygen fraction and/or of an air mass flow and/or of an exhaust gas recirculation rate and/or of an oxygen mass in a cylinder charge and/or of an inert gas rate and/or of an inert gas mass in a cylinder charge.

3. The method according to claim 1, wherein the at least one correction variable is determined while allowing for actual variables of an injection system of the internal combustion engine and/or of an air system and/or of an exhaust system of the internal combustion engine.

4. The method according to claim 1, wherein the at least one correction variable is formed and/or used only when the result of the comparison and/or the respective correction variable exceeds or undershoots a respective threshold value.

5. The method according to claim 1, wherein at least two unwanted exhaust components are reduced, and in that at least one correction variable is determined for each of the unwanted exhaust components, and in that the correction variables determined in this way are each rated individually, and in that the correction variables rated in this way are used to correct the at least one setpoint.

6. The method according to claim 1, wherein a first unwanted exhaust component is soot and a second unwanted exhaust component is at least one nitrogen-oxygen compound.

7. The method according to claim 1, wherein the comparison value of the air ratio is determined in accordance with a soot limit value dependent on the operating point and/or with a soot fraction in steady-state operation of the internal combustion engine and/or with a reference air ratio in steady-state operation of the internal combustion engine.

8. The method according to claim 1, wherein the comparison value of the oxygen fraction is determined in accordance with an NOx limit value dependent on the operating point and/or with an NOx fraction in steady-state operation of the internal combustion engine and/or with a reference oxygen fraction in steady-state operation of the internal combustion engine.

9. The method according to claim 1, wherein the actual air ratio and/or the actual oxygen fraction in the intake pipe are determined by means of at least one sensor and/or at least one model.

10. The method according to claim 1, wherein at least one of the following variables:
the soot limit value dependent on the operating point;
the soot fraction in steady-state operation;
the reference air ratio;
the NOx limit value dependent on the operating point;
the NOx fraction in steady-state operation;
the reference oxygen fraction; and/or
an exponent “n” or “k”, which is a component in a formula for combining in each case at least two of said variables,
is determined by means of at least one characteristic or at least one characteristic map.

11. A computer program (42), to carry out a method according to claim 1.

12. An open-loop and/or closed-loop control device for an internal combustion engine, the control device comprising a memory, in which a computer program according to claim 11 is stored.
